(19) United States
(12) Patent Application Publication
(10) Pub. No.: US 2003/0057051 A1
(43) Pub. Date: Mar. 27, 2003

(54) Hydraulically operated double clutch

(76) Inventor: Sverker Alfredsson, Vastra (SE)

Correspondence Address: YOUNG & THOMPSON, 745 SOUTH 23RD STREET 2ND FLOOR, ARLINGTON, VA, 22202

(21) Appl. No.: 10/149,765

(22) PCT Filed: Dec. 11, 2000
(86) PCT No.: PCT/SE00/02481

(30) Foreign Application Priority Data
Dec. 13, 1999 (SE) 9904548-6

(51) Int. Cl. F16D 25/10

(52) U.S. Cl. 192/87.15; 192/106 F

(57) ABSTRACT

Hydraulically operated double clutch with first and second piston-cylinder devices for engagement and disengagement of the respective clutch unit. The cylinder chamber (17) of the first piston-cylinder device is delimited between its piston (18) and a first wall (4) of the clutch housing (1), while the cylinder chamber (24) of the second piston-cylinder device is delimited between its piston (25) and the first mentioned piston (18). First and second peripherally spaced helical springs bias the pistons in the disengagement direction. The piston (18) of the first piston-cylinder device is provided with axially directed fingers, which are arranged between the springs (19) at substantially the same radius (r) as the mean radius of the pressure plate (8) of the first clutch unit and which, upon supply of pressure medium to the cylinder chamber (17) press against the pressure plate to engage the first clutch unit.

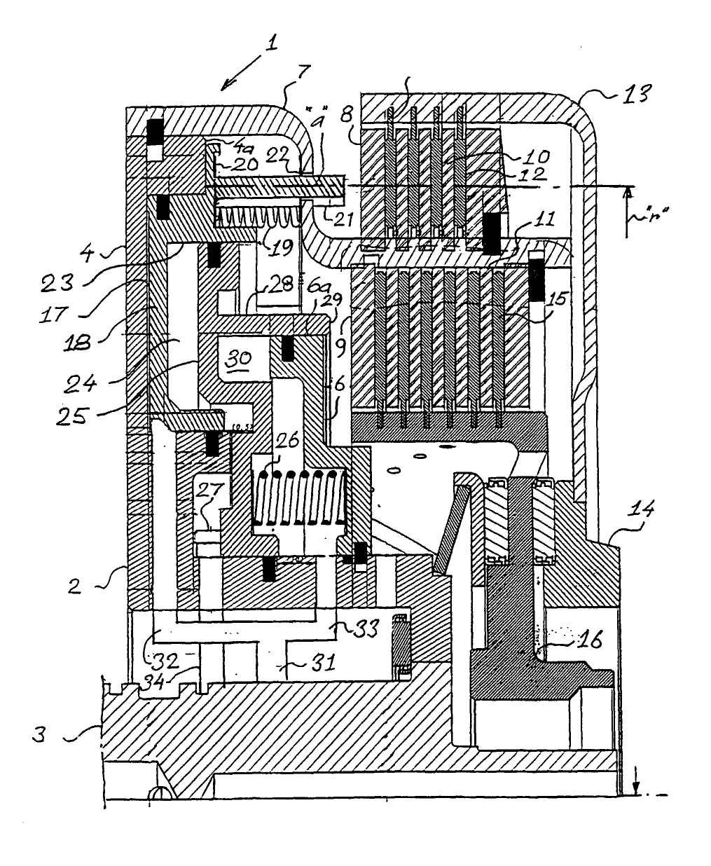

The present invention relates to a clutch arrangement, comprising an input clutch element intended to be drivably connected to an output shaft from a drive unit, a first output clutch element for driving a first input shaft to a transmission, a second output clutch element for driving a second input shaft to the transmission, said second input shaft being arranged concentrically to the first input shaft, a first clutch disc package having clutch discs joined alternatingly to the input clutch element and the first output clutch element, a second clutch disc package which is concentrically arranged radially inside the first clutch disc package and has clutch discs alternatingly joined to the input clutch element and the second output clutch element, first and second piston-cylinder devices, respectively, coordinated with the first and second disc packages, respectively, said piston-cylinder devices, upon supply of pressure medium to the respective cylinder chambers, being arranged to compress associated disc packages and establish driving connection between the input clutch element and the respective output clutch element, and first and second peripherally spaced helical springs which bias the piston of the respective piston cylinder device in the disengagement direction.

Clutch arrangements of this type are used, for instance, in vehicle gearboxes of the so-called power shift type, i.e. gearboxes with input shafts, which are each coupled to an individual clutch unit in a double clutch (see e.g. SE-8700583-1). In such gearboxes, the gear speeds can be preselected. Shifting is effected by disengaging one clutch and engaging the other clutch. Depending on the general construction of the clutch and available space, it happens that the return springs of the pistons are placed so that the surfaces of the pistons pressing against the pressure plates happen to be offset relative to the mean radius of the pressure plates. This can have the result that the pressure plates will arch when pressed, thereby unevenly loading the clutch discs.

The purpose of the present invention is in general to achieve a clutch of the type described by way of introduction, which has a simple, compact and reliable construction. In particular, the purpose is to achieve a clutch which makes it possible to assure even loading of the clutch discs when the pistons press against the pressure plates.

This is achieved according to the invention by virtue of the fact that the first clutch element forms a clutch housing and that the piston of the first piston-cylinder device is made with peripherally spaced, axially directed fingers, which extend through openings in the clutch housing and, upon supply of pressure medium to the cylinder chamber and accompanying displacement of the piston, push against a pressure plate of the first clutch disc package to establish driving connection between the clutch housing and the first output clutch element, the central axes of the springs and the fingers lying at a radius which at least nearly coincides with the mean radius of the pressure plate.

The invention will be described in more detail below with reference to examples shown in the accompanying drawing, where the FIGURE shows a longitudinal section through one embodiment of a clutch according to the invention.

The clutch shown in the drawing has a clutch housing, generally designated 1, comprising a housing body 2, which is joined to a tubular element 3 intended to be drivably connected to a driving element, for example an output shaft from a torque converter (not shown). The housing body 2 has a first end wall 4 with a cylindrical flange 4a and a second end wall 6 with a cylindrical flange 6a. The housing 1 also includes a cover 7, which is solidly joined to the end wall 4 and non-rotatably but displaceably carries first and second pressure plates 8 and 9, respectively, and first and second sets of clutch discs 10 and 11, respectively. The discs 10 are included in a disc package, which also includes discs 12, which are non-rotatably but displaceably connected to a cover 13 which is solidly joined to a hub 14, which is intended to be non-rotatably connected to a tube shaft (not shown), which can be a first input shaft in the so-called power shift gearbox. The discs 11 are included in a disc package which also includes discs 15, which are non-rotatably but displaceably joined to a hub 16, which is intended to be joined to a second shaft (not shown) concentric to the first shaft.

The end wall 4 and the flange 4a form a hydraulic cylinder with a cylinder chamber 17, in which a first hydraulic piston 18 is displaceably housed. The piston 18 is biased towards the position shown in the drawing by peripherally evenly spaced helical springs 19, which are tensioned between the inside of the cover 7 and a radial flange 20 on the piston 18. Radially inside the springs 19, the piston 18 is provided with axially directed, peripherally evenly spaced fingers 21, which project through openings 22 in the cover 7. When hydraulic fluid under pressure is supplied to the cylinder chamber 17, the piston 18 will be displaced to the right in the FIGURE, and the fingers 21 will come into contact with the pressure plate 8 and compress the disc package 10, 12, so that a driving connection is established between the clutch housing and the hub 14. The springs 19 are spaced between the fingers 21 in the example shown, but they can alternatively be arranged so that the springs 19 surround the fingers 21. In both cases it is important that the central axes (not shown) of the springs 19 and the central axes “a” of the fingers must lie at least nearly on the mean radius “r” of the pressure plate 8 to achieve pressing contact with the pressure plate which is as uniform as possible.

The piston 18 is provided with a cylindrical flange 23, which together with the remaining portion of the piston forms a hydraulic cylinder with a cylinder room 24, in which a second hydraulic piston 25 is displaceably housed. The piston 25 is biased towards the position shown in the drawing by peripherally evenly spaced helical springs 26, which are tensioned between the inside of the second end wall 6 and the piston. Peripherally evenly spaced heels 27 determine the end position of the piston 25 in the disengagement direction. The piston 25 is also provided with a cylindrical flange 28. When hydraulic fluid under pressure is supplied to the cylinder chamber 24 and the piston 25 is displaced to the right in the FIGURE, the end surface 29 of the cylindrical flange 28 will come into contact with the pressure plate 9 and compress the disc package 11, 15, thereby establishing a drive connection between the clutch housing 1 and the hub 16.

The flange 28 of the second piston 25 defines, together with the remaining portion of this piston and the second end wall 6 and its flange 6a, a third cylinder chamber 30. As is schematically illustrated with the channels 31, 32 and 33, hydraulic fluid is supplied under pressure also to the third cylinder chamber 30 when hydraulic fluid is supplied to the first cylinder chamber 17, when a driving connection is to be established between the clutch housing 1 and the hub 14. This means that both the force acting on the second piston 25 created by the oil pressure in the third cylinder chamber 30 and the force from the return springs 26 counteract the force acting in the engaging direction caused by the centrifugal force on the fluid in the second cylinder chamber 24. This means in turn that the return springs 26 can be less heavy than if the springs, as in previously known clutches of the type in question, had to overcome the centrifugal force on their own.

When a drive connection is to be established between the clutch housing 1 and the second hub 16, the first and third cylinder chamber 17 and 30, respectively, are drained via the channels 31, 32 and 33, and the second cylinder chamber 24 is supplied with hydraulic fluid under pressure via a channel 34. At the same time as the oil pressure in the cylinder chamber 24 presses the second piston 25 to the right in the FIGURE to compress the disc package 11, 15, the reactive force created by the oil pressure together with the return springs 19 presses the first piston 18 to the left to the end position shown in the drawing. This means that the clutch formed of the disc package 10, 12 will be released at the same time as the second clutch formed of the disc package 11, 15 will be engaged. As is the case with the return springs 26, the return springs 19 of the first clutch can be dimensioned less strong than what would otherwise be required without the assistance of the return force on the first piston 18 created by the oil pressure. The axial extents of the fingers 21 and the heels 27 are selected so that the fingers can reach the pressure plate 8 and compress the disc package 10, 12 to complete engagement without being impeded by the second piston 25 when it is in its left hand end position shown in the drawing.

1. Clutch device, comprising an input clutch element (1) intended to be drivably connected to an output shaft from a drive unit, a first output clutch element (14) for driving a first input shaft to a transmission, a second output clutch element (16) for driving a second input shaft to the transmission, said second input shaft being arranged concentrically to the first input shaft, a first clutch disc package having clutch discs (10, 12) joined alternatingly to the input clutch element and the first output clutch element, a second clutch disc package (11, 15) which is concentrically arranged radially inside the first clutch disc package and has clutch discs alternatingly joined to the input clutch element and the second output clutch element, first and second piston-cylinder devices, respectively (18, 17 and 25, 24, respectively), coordinated with the first and second disc packages, respectively, said piston-cylinder devices, upon supply of pressure medium to the respective cylinder chambers, being arranged to compress associated disc packages and establish driving connection between the input clutch element and the respective output clutch element, and first and second peripherally spaced helical springs (19, 26) which bias the piston of the respective piston cylinder device in the disengagement direction, characterized in that the first clutch element forms a clutch housing (1) and that the piston (18) of the first piston-cylinder device is made with peripherally spaced, axially directed fingers (21), which extend through openings (22) in the clutch housing and, upon supply of pressure medium to the cylinder chamber (17) and accompanying displacement of the piston, push against a pressure plate (8) of the first clutch disc package to establish driving connection between the clutch housing (1) and the first output clutch element (14), the central axes (a) of the springs and the fingers lying at a radius which at least nearly coincides with the mean radius (r) of the pressure plate.

2. Clutch device according to claim 1, characterized in that the fingers (21) extend through the helical springs (19).

3. Clutch device according to claim 1, characterized in that the fingers (21) are arranged in the spaces between the springs (19).

4. Clutch device according to one of claims 1-3, characterized in that the cylinder chamber (17) of the first piston-cylinder device is delimited between its piston (18) and a first wall (4) of the clutch housing, that the cylinder chamber (24) of the second piston-cylinder device is delimited between its piston (25) and the piston (18) of the first piston-cylinder device, that a third cylinder chamber (30) is delimited between the piston of the second piston-cylinder device and a second wall (6) of the clutch housing, and that channels (31-33) for pressure medium to the cylinder chambers are arranged so that operating pressure prevails at the same time in the first and third cylinder chambers.
